(19) United States
(12) Patent Application Publication
(10) Pub. No.: US 2018/0151324 A1
(43) Pub. Date: May 31, 2018

(54) HEAT SINK FOR X-RAY TUBE ANODE

(71) Applicant: VAREX IMAGING CORPORATION, Salt Lake City, UT (US)

(72) Inventors: Patrick K. Lewis, West Jordan, UT (US); Gregory C. Andrews, West Jordan, UT (US); Tyler Lee, Palo Alto, CA (US)

(21) Appl. No.: 15/465,499

(22) Filed: Mar. 21, 2017

Related U.S. Application Data
(60) Provisional application No. 62/426,487, filed on Nov. 26, 2016.

(51) Int. Cl. H01J 35/12

(52) U.S. Cl. CPC H01J 35/12

(57) ABSTRACT

Disclosed is an X-ray tube having an electron source and anode disposed therein. The anode includes a target surface positioned to receive electrons emitted by the electron source. A thermal structure is interfaced directly with the anode. The thermal structure defines a fluid passageway that is configured to receive and circulate a coolant. A thermally conductive porous matrix is disposed within the fluid passageway so as to facilitate the transfer of heat generated at the target surface to the coolant.

### CROSS-REFERENCE TO RELATED APPLICATION

This application claims priority to U.S. Provisional Application No. 62/426,487, filed Nov. 26, 2016, titled HEAT SINK FOR X-RAY TUBE ANODE, which is incorporated herein by reference in its entirety.

### BACKGROUND

Disclosed embodiments relate generally to X-ray tube devices. In particular, embodiments relate to cooling systems that employ a heat sink to increase the rate of heat transfer from X-ray tube components to a coolant.

X-ray producing devices are used in a wide variety of applications, both industrial and medical. Such equipment is commonly used in applications such as diagnostic and therapeutic radiology, semiconductor manufacture and fabrication, and materials testing. While used in a number of different applications, the basic operation of an X-ray tube is similar. In general, X-rays, or X-ray radiation, are produced when electrons are produced, accelerated, and then impinged upon a material of a particular composition.

Regardless of the application in which they are employed, X-ray devices typically include a number of common elements including a cathode, or electron source, and an anode situated within an evacuated enclosure in a spaced apart arrangement. The anode includes a target surface oriented to receive electrons emitted by the cathode. In operation, an electric current applied to a filament portion of the cathode causes electrons to be emitted from the filament by thermionic emission. The electrons then accelerate towards a target surface of the anode under the influence of an electric potential applied between the cathode and the anode. Upon approaching and striking the anode target surface, many of the electrons either emit, or cause the anode to emit, electromagnetic radiation of very high frequency, i.e., X-rays. The specific frequency of the X-rays produced depends in large part on the type of material used to form the anode target surface. Anode target surface materials with high atomic numbers (“Z” numbers) are typically employed. The X-rays exit the X-ray tube through a window in the tube, and enter the x-ray subject. As is well known, the X-rays can be used for therapeutic treatment, X-ray medical diagnostic examination, or material analysis procedures.

Some of the electrons that impact the anode target surface convert a substantial portion of their kinetic energy to x-rays. Many electrons, however, do not produce X-rays as a result of their interaction with the anode target surface, but instead impart their kinetic energy to the anode and other X-ray tube structures in the form of heat. As a consequence of their substantial kinetic energy, the heat produced by these electrons can be significant. The heat generated as a consequence of electron impacts on the target surface must be reliably and continuously removed or otherwise managed. If left unchecked, it can ultimately damage the x-ray tube and shorten its operational life. Moreover, removal of excessive heat allows for a proportional increase in the power capacity of the X-ray tube system, thereby increasing image quality.

### BRIEF DESCRIPTION OF THE DRAWINGS

A more particular description of the claimed invention will be rendered by reference to example embodiments, which are illustrated in the appended drawings. It is appreciated that these drawings depict only example embodiments and are therefore not to be considered limiting of its scope.

FIG. 1 is a perspective view of one example of an X-ray tube and an external cooling unit;

FIG. 2 is a cross-section view of the X-ray tube of FIG. 1;

FIG. 3A is a top perspective view of one example of an embodiment of an anode configured for use in connection with the X-ray tube of FIG. 1;

FIG. 3B is a bottom perspective view of one example of an embodiment of an anode configured for use in connection with the X-ray tube of FIG. 1;

FIG. 4 is a cross-section view of the anode of FIG. 3A taken along lines 4-4;

FIG. 5 is an exploded view of a portion of the thermal structure embodiment of FIG. 4;

FIG. 6 is a cross-section view of an anode of FIG. 4 with an exploded view showing a another embodiment of a thermal structure; and

FIG. 7 is a cross-section view of an anode of FIG. 4 with an exploded view showing another embodiment of a thermal structure.

### DETAILED DESCRIPTION OF SOME EXAMPLE EMBODIMENTS

In the following detailed description of the embodiments, reference is made to the accompanying drawings that show, by way of illustration, example embodiments of the invention. In the drawings, like numerals describe substantially similar components throughout the several views. These embodiments are described in sufficient detail to enable those skilled in the art to practice the invention. Other embodiments may be utilized and structural, logical and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

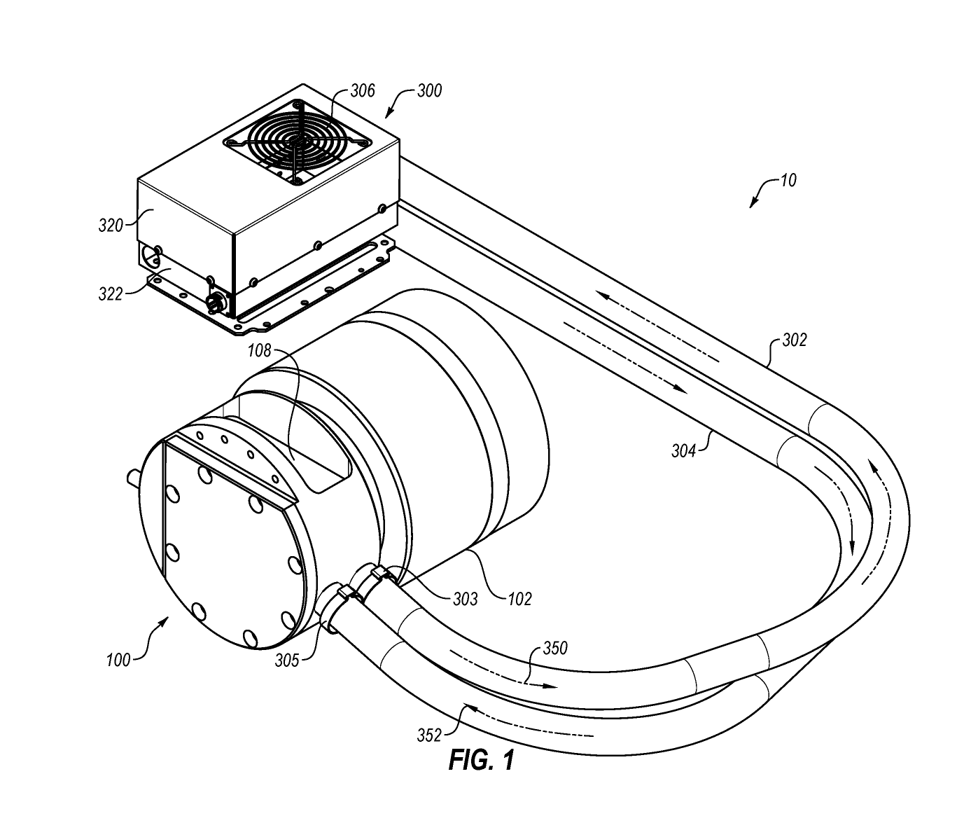

Referring first to FIG. 1, an X-ray assembly is depicted generally at 10. In this example, X-ray assembly 10 includes an x-ray tube 100 and an external cooling unit 300 that is operatively connected to the x-ray tube 100 by way of a coolant delivery conduit 304 and a coolant return conduit 302. X-ray tube 100 includes an outer housing 102, including appropriate connection ports for operative connection to the conduits 302 and 304, as will be described further below. Also formed within outer housing 102 is an x-ray window, denoted at 108, formed of an x-ray transmissive material, such as beryllium, that allows x-rays to be emitted toward an object under inspection.

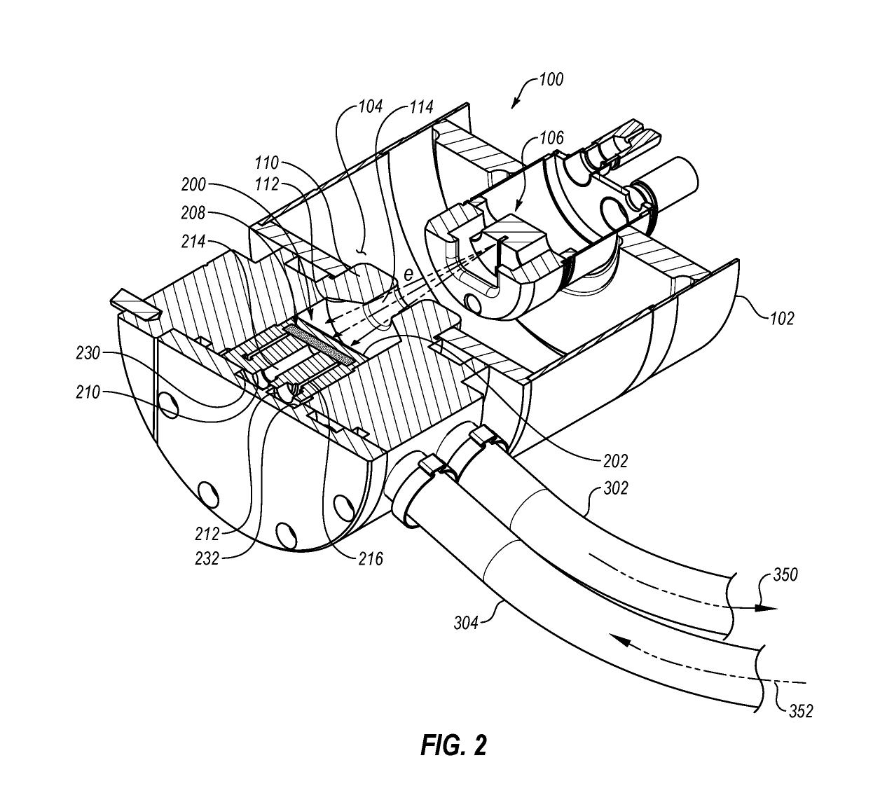

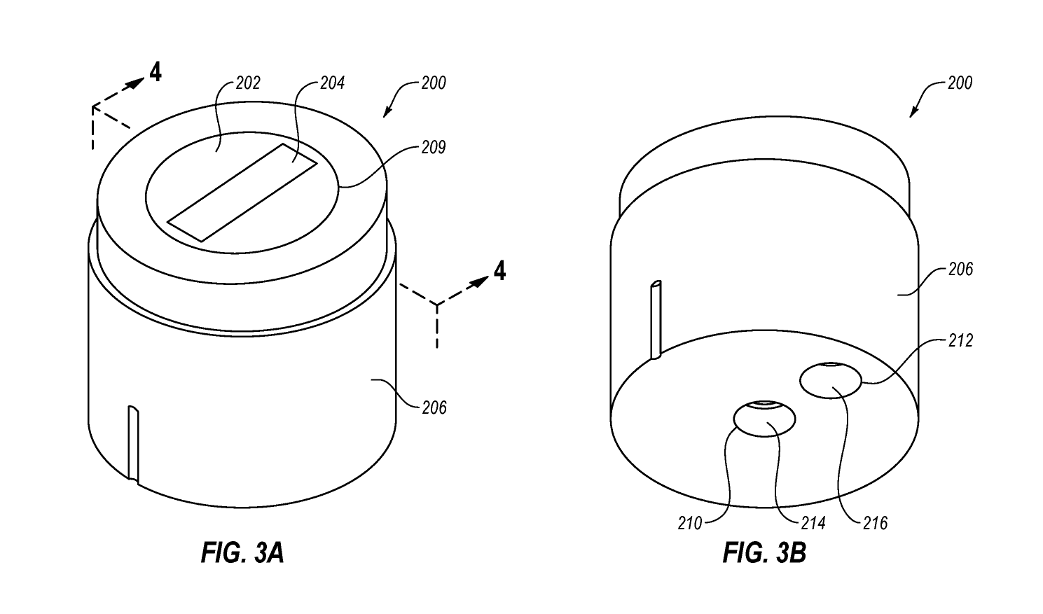

Referring to FIG. 2, formed within the housing 102 is a vacuum enclosure 104 within which is disposed a cathode, denoted generally at 106, and an anode, denoted generally at 200. In the illustrated embodiment, anode 200 is fixed, or stationary although alternate configurations may be used. Disposed at the target end 202 of the anode 200 is a target surface 204 (shown in FIG. 3A), which preferably comprises a material with a high atomic (high “Z”) number, such as tungsten, titanium, rhodium, platinum, molybdenum, or chromium (or combinations thereof) or any other material that is capable of efficiently generating X-rays when impinged with the high velocity electron stream.

In operation, an electrical current is supplied to the cathode 106, such as a filament component (not shown), which causes a cloud of electrons (denoted at “e” in FIG. 2) to be emitted from the filament surface by way of thermionic emission. A voltage potential difference is applied between the cathode 106 and the anode 200, which in turn causes the electrons to accelerate to a high velocity and travel along a path towards the target surface 204 of anode 200. As a consequence of this high velocity, the electrons “e” possess a relatively large amount of kinetic energy as they approach target surface 204. When the electrons “e” collide with the target surface 204, a portion of this kinetic energy is converted to X-rays (not shown). The target surface 204 may be formed at a slight angle, or at another suitable orientation, such that the resultant x-rays are directed through the window 108 of x-ray tube 100, and ultimately into an x-ray subject.

As is shown in the example embodiment, although not required, a shield structure 110 may be positioned between the cathode 106 and the anode 200 within vacuum enclosure. The shield 110 may define an aperture (denoted at 114) that is sized and shaped so as to substantially prevent errant electrons from impacting anode 200 other than at target surface 204. The shield 110 may also include an electron collection surface, denoted at 112, formed at one end of aperture 114, which is shaped (here, concave) so as to function to collect electrons that rebound from the target surface 204 (sometimes referred to as “backscattered” electrons) thereby minimizing such electrons from re-impacting anode 200 or other areas within the evacuated enclosure so as to avoid further heat generation and/or off-focus radiation.

Referring again to FIG. 1, additional details regarding the structure and components of external cooling unit 300 are provided. In particular, cooling unit 300 contains a volume of coolant (not shown). One embodiment of external cooling unit 300 comprises a reservoir 320, a fluid pump 322 configured to deliver coolant at a desired flow rate and/or delivery pressure, and a heat exchanger device, such as a fan and/or radiator combination 306 or the like, configured to work in concert to continuously circulate coolant through x-ray tube 100 and anode 200 so as to remove heat from anode 200 and/or other structures of x-ray tube 100. Note that heat exchange devices such as external cooling unit 300 are well known in the art. Accordingly, it will be appreciated that a variety of other heat exchange devices and/or components may be employed to provide the functionality of external cooling unit 300, as disclosed herein.

Any one of a different types of coolants can be used to provide adequate heat transfer into the coolant. For example, a 50% water/50% glycol combination can be used as a cooling fluid. Pure (or deionized) water may also be used, but due to a closed loop cooling system a bacterial growth inhibitor (such as glycol) can be added. If needed, a coolant with dielectric proprieties can be used if the coolant is used as part of the electrical insulation of the x-ray tube, such as a dielectric oil (e.g., Shell Diala Oil AX and Syltherm 800). It will be appreciated that the coolant could comprise any other appropriate coolant that is capable of performing the functions of heat absorption and removal, as enumerated herein. Note that, as contemplated herein, “coolant” includes, but is not limited to, both liquid and dual phase coolants.

With continuing reference to FIGS. 1 and 2, external cooling unit 300 communicates with x-ray tube 100 (and components therein, as described further below) via fluid conduits 302 and 304. In the illustrated embodiment, conduit 304 operates as the coolant delivery conduit for providing coolant to the x-ray tube that has had heat removed via a heat exchanger device incorporated within cooling unit 300, and conduit 302 operates as coolant return conduit for returning heated coolant to unit 300. Note that the functionality provided by fluid conduits 302 and 304 (discussed below) may be achieved with any of a variety of components or devices including, but not limited to, hoses, tubing, pipe, or the like. As is shown in FIG. 1, fluid conduits 302 and 304 may be operatively attached to x-ray tube housing via any suitable mechanism that maintains a fluid tight fit, such as clamp structures denoted at 303 and 305. Of course, any other suitable attachment structure might be used.

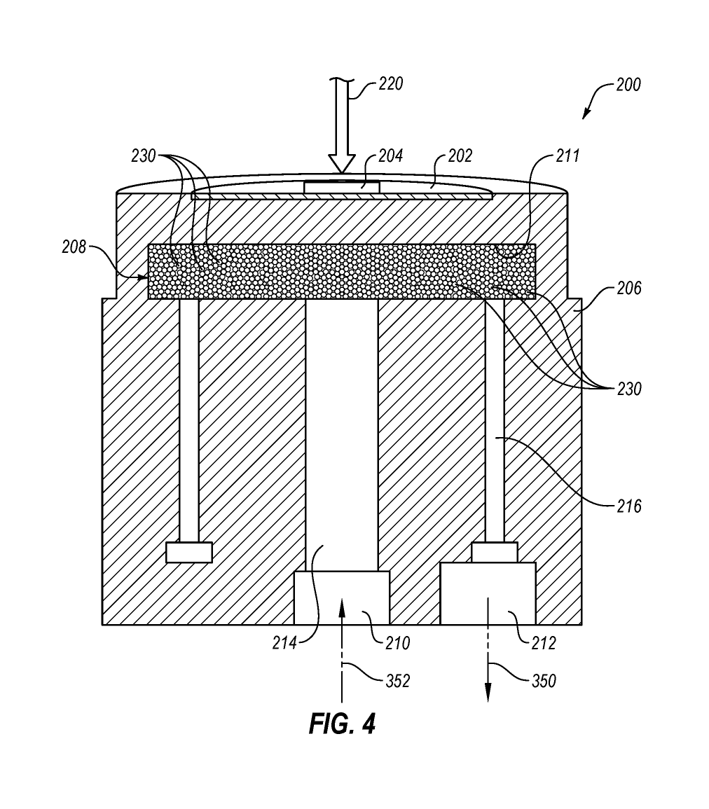

Reference is next made to FIGS. 2-4 for further details relating to example embodiments of the anode 200. As is best seen in FIG. 2, anode 200 may be disposed within evacuated enclosure 104 such that target surface 204 is positioned to receive electrons “e” emitted from cathode 106, as discussed above. In the embodiment shown, anode 200 includes a main body portion 206 that may be formed of a material that possesses a suitably high thermal conductivity, such as copper or copper alloys, although other materials having suitable thermal conductivity could also be used. The high thermal conductivity of anode 200 facilitates dissipation of at least some of the thermal energy (denoted at arrow 220 in FIG. 4) produced at target surface 204 resulting from the interactions between electrons “e” and target surface 204.

As is further shown in FIG. 2 and in the cross-section view of anode 200 in FIG. 4, also illustrated is a thermal structure, or a heat sink, that is interfaced directly with the anode 200. In an illustrated example, a thermal structure, denoted at 208, is interfaced directly with the anode by integrating the thermal structure 208 within the main body portion 206 of anode 200 at a point that is below the target surface 204. In this way, thermal energy 220 that is generated at, or in the region of, the target surface 204 is thermally conducted to the thermal structure 208 via the intervening body portion 206 of anode 200. It will be appreciated that the thermal structure could be interfaced directly with the anode 200 in ways other than integrating it within the body portion 206. For example, thermal structure could be implemented in a separate component that in turn is placed in thermal contact with the anode target end 202. Other configurations could also be used, depending on the position of the target surface 204, the orientation and shape of the anode 200, and overall configuration and thermal requirements of the x-ray tube 100.

In the illustrated embodiment, the thermal structure 208 is cylindrical in shape, and forms a fluid passageway reservoir 211 that is configured to receive coolant, as will be described in further detail below. In one embodiment, the outer periphery of the thermal structure 208 is approximately the size and shape of the periphery denoted by the line at 209 in FIG. 3A, so as to be in substantially contiguous thermal contact with the entire width and length of the target surface 204. Again, depending on the particular shape and size of a given anode and target surface, as well as specific thermal requirements, this size and/or shape could be changed, including by providing a varying shape along its length. For example, instead of a cylindrical (from a top view) shape, the reservoir 211 defined by the thermal structure 208 could be rectangular, or any other appropriate shape, including a non-uniform shape needed to correspond with a given target surface shape. Also, instead of a uniform width along its length, the width (from a side view) may vary, again depending on specific thermal requirements (e.g., a larger width in certain regions that correspond to higher heat areas of a given target surface).

As noted, the thermal structure 208 is configured to define at least one fluid passageway, which in the illustrated example is denoted at 211. As is illustrated, the fluid passageway may be a configured so as to form a single contiguous reservoir. Alternatively, the thermal structure may define two or more passageways. Further, while the illustrated example shows a single contiguous passageway, in alternative embodiments there may be fins, partial walls, or other similar structures formed within the one or more passageways.

As can be seen in FIG. 3B, and in the cross-section of FIG. 4, the thermal structure 208 includes at least one fluid inlet channel, denoted at 214, and at least one fluid outlet channel, denoted at 216. The fluid inlet channel 214 is in fluid communication with fluid conduit 304, and the fluid outlet channel 216 is in fluid communication with fluid conduit 302. In this way, coolant is introduced into the fluid passageway reservoir 211 under pressure from the external cooling unit 300 via inlet channel 214 and conduit 304, and coolant returns to the cooling unit from the passageway reservoir 211 via outlet channel 216 and conduit 302. In the illustrated embodiment, the inlet channel 214 and the outlet channel 216 are each integrally formed within the main body portion 206, although other fluid conduit structures could be used.

As is also shown in FIG. 2, the fluid inlet channel 214 is in fluid communication with fluid conduit 304 by way of an inlet port 214, and the fluid outlet channel 216 is in fluid communication with fluid conduit 302 by way of an outlet port 216. In the illustrated example, inlet port 214 and outlet port 216 may each be formed at the base of the main body portion 206, each of which are interfaced with channels (denoted at 230 and 232 in FIG. 2) that in turn communicate with conduit 304 and conduit 302 respectively. Channels 230, 232 may be formed within a portion of x-ray tube housing 102, either directly within walls of the structure (as shown) or by way of separate tubes, pipes or the like.

This recirculation of coolant through the fluid passageway reservoir 211 may be continuous, thereby enhancing the removal of heat that is generated at the target surface 204 (or other regions of the anode 200). In particular, heat generated 220 at the target surface 204 is thermally conducted to the thermal structure 208 and absorbed by the coolant entering (denoted at 352) and then circulating through the fluid passageway reservoir 211. The heated coolant is returned (denoted at 350) to the external cooling unit 300, and the process repeated.

To enhance the removal of thermal energy, embodiments further include a thermally conductive porous matrix that is disposed within the fluid passageway reservoir 211. The thermally conductive porous matrix acts to facilitate and enhance the transfer of heat generated at the target surface to the coolant that is circulating within the fluid passageway 211. For example, inclusion of the conductive porous matrix increases the relative effective surface area between the coolant and the heated surfaces that are conducting heat generated in the anode regions, such as the target surface 204. Moreover, the porous nature of the matrix facilitates improved heat transfer from the anode to the coolant due to the increased velocity of coolant flow, which is at least partially a function of the cross-sectional area of the passageways provided by the porous matrix. For a constant rate of flow, the velocity of the coolant increases as the cross-sectional area of the passageways (formed by the porous configuration) decreases. Accelerating a flow of coolant and then impinging the accelerated coolant on the surface(s) of the porous matrix is a more efficient method of convective cooling.

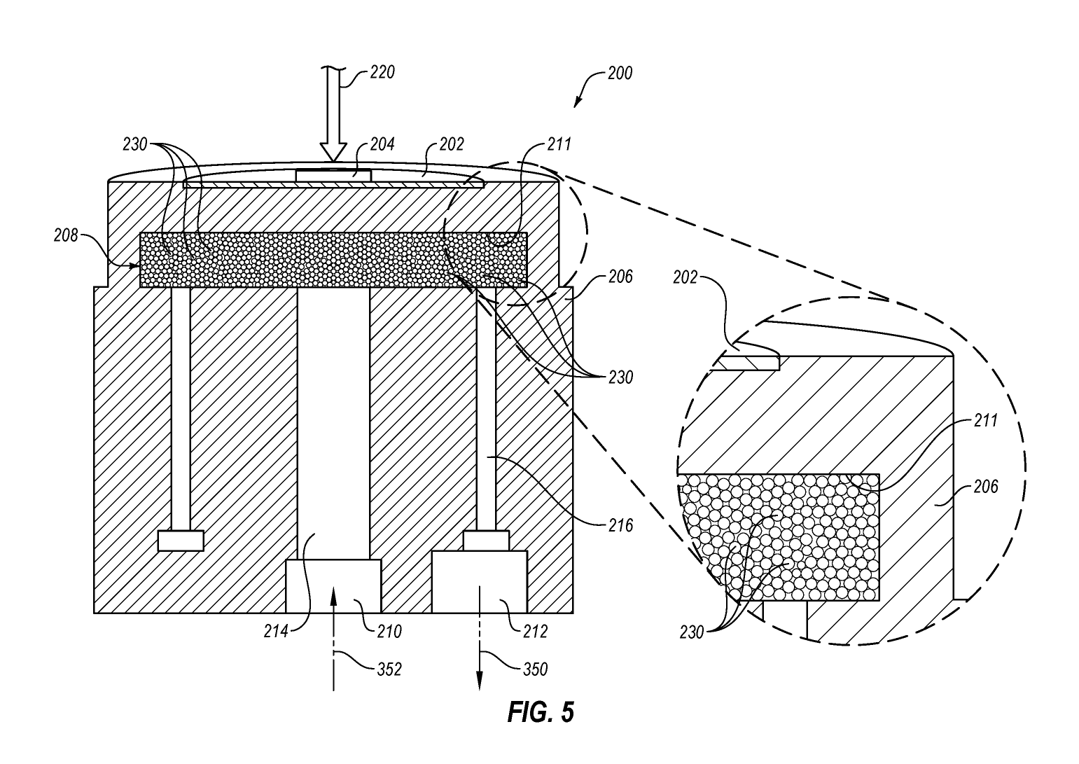

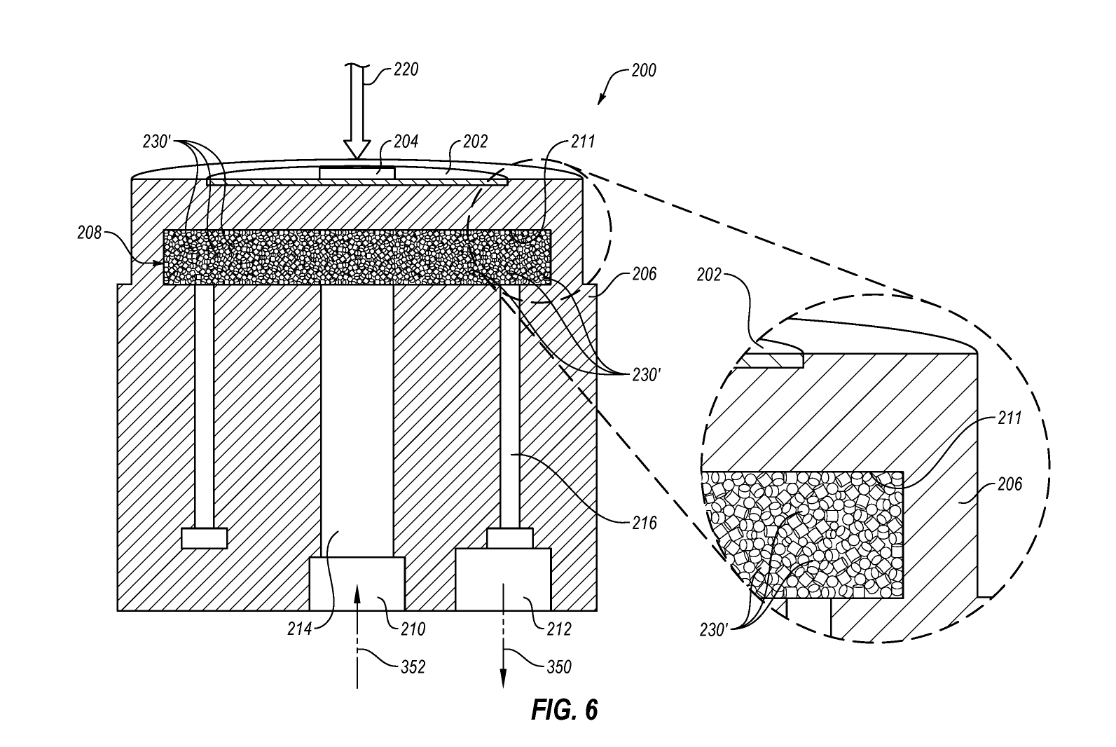

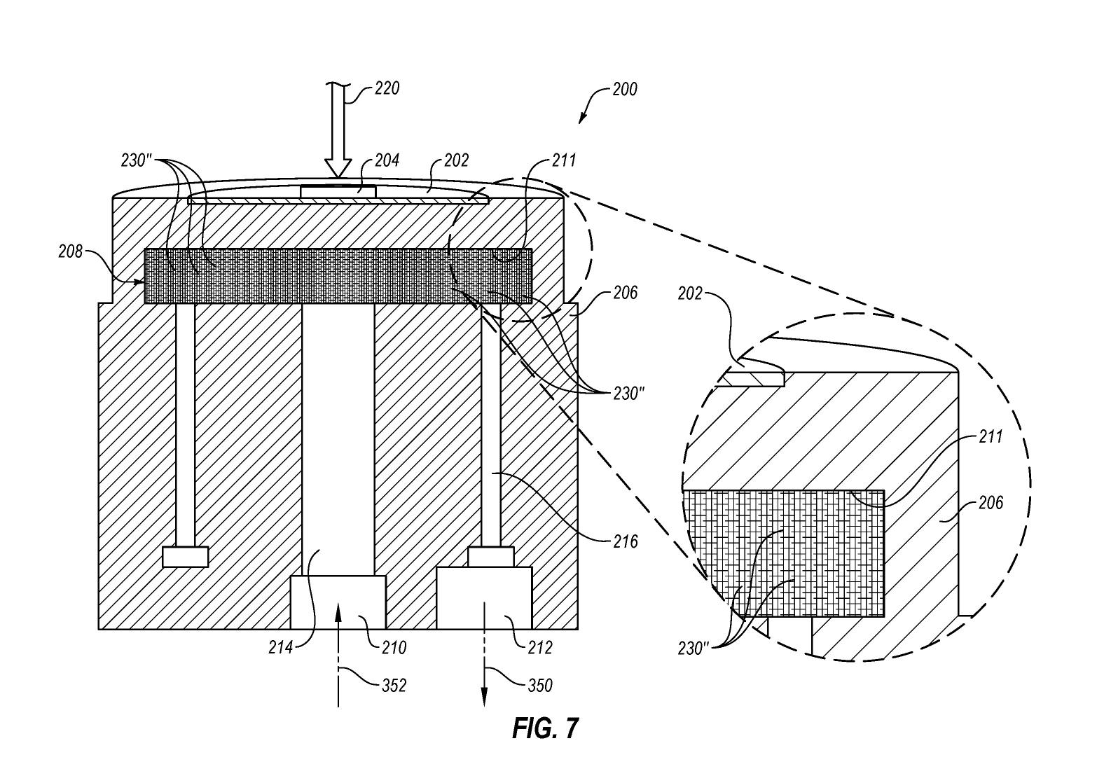

Referring to FIGS. 4 and 5, in one embodiment the thermally conductive porous matrix may be comprised of multiple a plurality of particles attached to one another, individually denoted at 230. In the illustrated embodiment of FIG. 4, the particles are approximately spherical in shape (shown in further detail in the exploded view of FIG. 5). The particles may be attached, such as by brazing or other suitable means to create a metallurgical bond between the particles and in a manner so as to form a porous matrix through which the coolant can pass. The particles may be comprised of a sufficiently thermally conductive material, such as copper. In alternative embodiments, the porous matrix might be comprised of particles having different shapes, such as a cylinders, an example of which is illustrated in the embodiment of FIG. 6 wherein cylindrical particles are denoted at 230′), or a combination of spheres and cylinders or other shapes. Also, the particles may be comprised of different materials having sufficiently high thermal conductivity and that are suitable for fabrication into a porous structure, such as brass, steel, tungsten, aluminum, magnesium, nickel, gold, silver, aluminum oxide, beryllium oxide, or the like. Shapes and/or materials can be selected to achieve varying degrees of thermal transfer and/or heat storage depending on the needs of a particular implementation. Other implementations of a suitable porous media might include the use of a porous graphite foam material, open-cell metal foam, knitted copper (or other similar metallic material) mesh matrix, (such as is represented in the example embodiment of FIG. 7 wherein a porous or mesh like structure is denoted at 230″), or a sintered bed of metal spheres and/or cylinders. Combinations of any of the foregoing may also be used so as to provide a porous structure through which coolant fluid may flow and thereby experience increased heat transfer. In addition, any of the foregoing might be used in combination with fins or other structures disposed within the passageway reservoir 211 so as to further enhance or augment heat transfer. Similarly, while the reservoir 211 is illustrated as a single passageway, it will be appreciated that the porous matrix could be implemented to provide multiple fluid paths within the thermal structure 208, again depending on the thermal requirements and heat removal configuration needed for a given anode implementation. Examples of implementations of a suitable porous matrix and related structures are disclosed in U.S. Pat. Nos. 7,044,199 and 6,131,650, each of which is incorporated herein by reference in its entirety.

In one embodiment, the individual particles are comprised of copper spheres that are approximately 0.5-1.0 millimeters (mm) in diameter. Other sizes (or combinations of sizes and shapes) can also be used, depending on, for example, porosity desired for a given fluid flow, heat transfer, and the like.

By way of example, the operation of an X-ray tube of the sort denoted at 100 proceeds generally as follows. External cooling unit 300 directs a flow of coolant 352 via conduit 304 into X-ray tube 100. The flow of coolant 352 is directed to a fluid passageway 211 formed within a thermal structure 208 via a fluid inlet channel 214 and inlet port 210 that is operatively connected to conduit 304. As the coolant enters the fluid passageway 211, it passes through a thermally conductive porous matrix. Since the thermal structure 208 is interfaced with anode 200, thermal energy 220 generated at the anode (particularly the target surface 204) conducts to the thermally conduct porous matrix, and is transferred to the circulating coolant. The heated coolant exits the passageway reservoir 211 via the fluid outlet channel 216 and the outlet port 212 and back to the external cooling unit 300 via fluid conduit 302 (flow denoted at 350). Heat is removed from the coolant by the cooling unit 300, and then recirculated.

To enhance convective cooling within the thermal structure 208, coolant may be circulated by pump disposed within the cooling unit 300 at appropriate fluid flow rate and/or pressure. Adjusting the flow rate through porous structure results in different rates of heat removal. In one embodiment, flow rates between about 0.4 and 0.62 gallons per minute (g.p.m) (between about 1.514 and 2.347 liters per minute) are used to prevent boiling of the fluid in the porous structure, and to prevent damage to the porous structure due to overly high delivery pressure or flow rate. Other fluid flow rates or fluid pressures may be used depending on the structural integrity of the porous structure, thermal characteristics, the type of coolant used, and the like.

By way of summary, disclosed embodiments are directed to an X-ray tube having improved cooling characteristics, particularly in the region of the anode. Example embodiments include an X-ray tube having a vacuum enclosure within which is disposed an electron source and anode. The anode, which in one disclosed embodiment is of a stationary type, includes a target surface positioned to receive electrons that are emitted by the electron source, for example, a filament disposed within a cathode head. As electrons strike the target surface, X-rays are generated. In addition, heat is generated in the region of the target surface. To assist in the removal of at least some of this heat, a thermal structure is interfaced directly with the anode. In one example, the thermal structure defines a fluid passageway that is configured to circulate a coolant, such as water, to absorb heat. In addition, a thermally conductive porous matrix is disposed within the fluid passageway so as to facilitate the transfer of heat generated at the target surface to the coolant circulating through the passageway. In some embodiments, a pump is used to continuously circulate the coolant through the fluid passageway, and a heat exchange device removes heat from the coolant before it is recirculated back to the thermal structure. Although various configurations can be used, the porous matrix is comprised of a thermally conductive material that is arranged in a porous matrix that permits circulation of the coolant through the passageway, and that increases the transfer of heat to the coolant. In one embodiment, the porous matrix is comprised of thermally conductive particles that are suitably interconnected or attached so as to provide the porous matrix.

Simulation data demonstrates that implementations using the above cooling techniques result in much improved thermal capacities and operational capabilities. For example, utilizing a thermal structure with a porous matrix allows for operation of the x-ray tube at higher energy inputs, and larger focal spot sizes (electron impact on the target surface), resulting in improved image quality.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An X-ray tube comprising:
a vacuum enclosure having an electron source and anode disposed therein, the anode having a target surface positioned to receive electrons emitted by the electron source;
a thermal structure interfaced directly with the anode, the thermal structure defining a fluid passageway that is configured to circulate a coolant; and
a thermally conductive porous matrix disposed within the fluid passageway so as to facilitate the transfer of heat generated at the target surface to the coolant.

2. The X-ray tube as defined in claim 1, wherein the fluid passageway includes an inlet configured to introduce the coolant into the fluid passageway, and an outlet configured to output the coolant from the passageway.

3. The X-ray tube as defined in claim 2, wherein the coolant is delivered at a predetermined pressure through the porous matrix.

4. The X-ray tube as defined in claim 2, wherein the coolant is delivered at a predetermined flow rate through the porous matrix.

5. The X-ray tube as defined in claim 1, further comprising a pump configured to deliver the coolant to the at least one fluid passageway.

6. The X-ray tube as defined in claim 1, wherein the thermally conductive porous matrix is arranged to define a plurality of fluid flow paths within the passageway.

7. The X-ray tube as defined in claim 1, wherein the thermal structure comprises a thermally conductive material.

8. The X-ray tube as defined in claim 1, wherein the matrix comprises a plurality of particles.

9. The X-ray tube as defined in claim 8, wherein the particles have a shape selected from the group consisting of substantially spherical and substantially cylindrical.

10. The X-ray tube as defined in claim 8, wherein the plurality of particles are attached to one another so as to form a porous matrix.

11. The X-ray tube as defined in claim 1, wherein the matrix comprises a structure selected from the group consisting of mesh, porous foam, and open-cell foam.

12. The X-ray tube as defined in claim 1, wherein the matrix is comprised of a material selected from the group consisting of carbon, copper, steel, brass, tungsten, aluminum, magnesium, nickel, gold, silver, aluminum oxide, beryllium oxide and graphite.

13. The x-ray tube as recited in claim 1, wherein the anode is substantially stationary with respect to the electron source.

14. An anode for an X-ray tube, the anode comprising:
a body having a first surface and a second surface, wherein the first surface includes a target region positioned to receive electrons;
a heat sink positioned adjacent to the first surface such that thermal energy generated in the target region conducts to the heat sink;
a fluid reservoir formed within an interior region of the heat sink and configured to receive a coolant; and
a plurality of particles attached to one another so as to form a porous matrix disposed within the fluid reservoir.

15. The anode as defined in claim 14, wherein the heat sink is attached directly to the second surface.

16. The anode as defined in claim 14, wherein the heat sink is integrated within the body between the first surface and the second surface.

17. The anode as defined in claim 14, wherein the particles are comprised of a thermally conductive material.

18. The anode as defined in claim 14, wherein the particles are substantially spherical in shape.

19. An x-ray tube cooling system for use in conjunction with an x-ray tube having a stationary anode, the x-ray tube cooling system comprising:
(a) at least one fluid passageway disposed proximate to the stationary anode so that a flow of coolant passing through the at least one fluid passageway absorbs at least some heat from the stationary anode;
(b) an external cooling unit, the external cooling unit circulating the flow of coolant through the at least one fluid passageway at a predetermined fluid flow rate; and
(c) a plurality of particles attached to one another so as to form a porous matrix disposed substantially within the at least one fluid passageway so that at least a portion of heat generated in the stationary anode is transmitted to the coolant as the coolant flows through the porous matrix.

20. In an x-ray tube including a vacuum enclosure having an electron source and an anode substantially disposed therein, the anode including a target surface positioned to receive electrons emitted by the electron source, a method for cooling at least a portion of the x-ray tube, the method comprising:
(a) providing a flow of coolant at a predetermined flow rate; and
(b) directing the coolant into contact with a plurality of particles attached to one another so as to form a porous matrix, wherein thermal energy generated at the target surface is conducted to the particles and transferred to the coolant via convection.
